(19) United States
(12) Patent Application Publication
(10) Pub. No.: US 2017/0237146 A1
(43) Pub. Date: Aug. 17, 2017

(54) Wireless Pole System and Platform

(71) Applicant: Manish K. Dureja, Owings, MD (US)

(72) Inventor: Manish K. Dureja, Owings, MD (US)

(21) Appl. No.: 15/583,812

(22) Filed: May 1, 2017

Related U.S. Application Data
(63) Continuation-in-part of application No. 15/001,677, filed on Jan. 20, 2016, now Pat. No. 9,642,186.

(51) Int. Cl. H01Q 1/12; H01Q 1/24; H01Q 1/52; H01Q 1/48; H01Q 1/50; H01Q 1/44

(52) U.S. Cl. CPC H01Q 1/1242; H01Q 1/50; H01Q 1/44; H01Q 1/526; H01Q 1/48; H01Q 1/246

(57) ABSTRACT

In one example, we describe a Stealth Wireless Pole System and Platform. In one example, we describe a system which: Accommodates all antennas, electrical power, fiber backhaul, e.g., to support up to 4 or 5 wireless service providers; Provides Wi-Fi and/or backhaul services managed by our company; Hides all equipment from view in a complete stealth design; Meets most or all zoning and planning, and permitting requirements for telecommunications facilities; Increases wireless capacity and coverage, including for public safety; Enables the Internet of Things environment by enabling device and service integration. Here, one can save money and resources by integrating all the functionalities and multiple carriers in one platform. The specific design and spec are also given for standing against natural elements, e.g., seismic, snow, and wind. Other variations and examples are also given here.

### RELATED APPLICATIONS

The current application is a CIP of the prior pending application, which was allowed, in U.S. Ser. No. 15/001,677, filed 20 Jan. 2016, with similar title, and same assignee. All the teachings (and including spec/appendices) of the parent case is incorporated here, by reference. We claim priority to the parent case, mentioned above, as well.

### BACKGROUND OF THE INVENTION

Usage on mobile networks is exploding. The total demand for mobile and data services is surpassing the available capacity, causing networks to become congested and fail. Now and over the next few years, capacity is and will be augmented through the use and deployment of additional wireless data standards and facilities, such as Wi-Fi, LTE-U and Small Cell wireless base station (cell site) equipment in large metropolitan, suburban, and rural areas. However, the concentrated deployment and installation of such equipment in a small area in cities or towns is not aesthetically pleasing, nor is practical for such equipment to be ubiquitously deployed or installed without consideration of costs to operate or impact on the community and environment.

Our solution is Stealth Wireless Pole System and Platform, shown below. The invention and embodiments described here, below, have not been addressed or presented in any prior art.

### SUMMARY OF THE INVENTION

In one embodiment, we describe stealth wireless poles. An architecture developed to provide the capacity and coverage needs of wireless users in the present and future and enable wireless carriers to share infrastructure via a neutral-host solution, will have the following spec, as an example:

Accommodates e.g. up to 5 wireless service providers

Provides e.g. Wi-Fi and/or backhaul services, managed by DAS Worldwide, our company

Hides and shields all equipment from view in a complete stealth design, e.g., against electromagnetic radiation, hackers, jamming, interference, or noise

Meets most zoning and planning, and permitting requirements for telecommunications facilities

Increases wireless capacity and coverage, including for public safety

Accommodates the Internet of Things, “IoT” by enabling devices and services interconnection

Saves money and resources by integrating all functionalities required to service multiple carriers into a single platform, with many technical and cost-sharing/saving advantages due to our unique design and components, mentioned below.

The specific design and spec are also given for standing against natural elements, e.g., seismic, snow, and wind.

### BRIEF DESCRIPTION OF THE DRAWINGS

FIG. 1 is for one embodiment, as an example, for our platform system, for pole (or pipe structure or shape) with various sections and components. Also, see Appendices 1-5 for more details.

FIG. 2 is for one embodiment, as an example, for our platform system, for pole installed in ground or on it or on a plate or slab or surface or structure or the like.

FIG. 3 is for one embodiment, as an example, for our platform system, for pole installed on water, floating on it, on a floater or small boat or wooden or plastic or fiber or metal or synthetic material container, or attached on top of it.

FIG. 4 is for one embodiment, as an example, for our platform system, for pole with various heating and cooling systems installed.

FIG. 5 is for one embodiment, as an example, for our platform system, for pole with various security systems installed.

FIG. 6 is for one embodiment, as an example, for our platform system, for pole with various components or subsystems or modules.

FIG. 7 is for one embodiment, as an example, for our platform system, for pole with various fan directions and speeds, with one or more fans, installed at different heights.

FIG. 8 is for one embodiment, as an example, for our platform system, for pole with double wall and jacket with various features for various functions.

FIG. 9 is for one embodiment, as an example, for our platform system, for pole with street lighting option, and flag option.

FIG. 10 is a system, for an example, for the tower.

### DETAILED DESCRIPTION OF THE PREFERRED EMBODIMENTS

Here are some embodiments, addressing the Stealth Wireless Pole (or “Smart Pole”) Electrical and Structural Components and Considerations:

A dedicated section of the pole is designed to contain electrical power metering equipment of the local power utility, with the ability of the utility to read, either visually, or electronically, power usage data by, or without, opening the pole. Here are the key points for electrical components:

A utility approved metering device that can be read through the metal enclosure around the bottom of the pole, either visually or electronically.

A Utility-approved breaker box

An electrical breaker box with an integrated single-gain “courtesy outlet”.

A power supply with sufficient capacity to support all equipment mentioned here in this disclosure, in any combinations.

Multiple radio heads, e.g., 4 or 5 units.

Support for multiple wireless operators or service providers, e.g., radio heads and Small Cell base stations.

Power Distribution gear.

Common Grounding Bar and common “bus-bar” all the way up the pole.

Conduit and/or other electrical raceways for running DC power and grounding to the top of the pole.

Any additional power distribution equipment, or PLCs as may be appropriate.

“Smart” power monitoring equipment.

Other power requirements as necessary to receive municipal Department of Transportation approval for a street side pole.

Any alternative back-haul or front-haul possibilities for dense metro pole deployments and C-RAN necessities such as microwave or copper.

Here are the key points for structural components:

Key structural requirements needed/used to receive municipal Department of Transportation approval for a street side pole.

Key structural requirements for the bottom 6 feet to accommodate all of the head-end power equipment, including protection for a possible small battery backup unit.

Supported wind load ratings.

To protect against RF degradation due to wind and other pole vibration events with our current small cell design goals.

Material used for the top half of pole that needs to be able to be penetrated by RF.

The pole may be internally anchored into foundation, or anchoring occurs outside. For all internal anchoring, there is space in the base of this pole.

A custom designed base cover for the anchors.

Workers accessing the various compartments of the pole. That is, any kind of hooks, pegs, etc., into pole for workers accessing, or requirements for them to use ladders, bucket truck, etc. to reach to top of the pole.

The crash rating and the key metrics for high-crash locations, when deciding on pole placements.

Internally bolster and protect the most important and expensive components inside of the pole, to protect in case of a crash, earthquake, high-wind event, or other disasters.

The ability to incorporate some type of breakaway device or impact absorption techniques to cut down on overall pole damage/crushing in the event of a crash event.

Each of the main components inside of the pole is either IP67 or IP30 “Ingress Protection” rated, as an example of environmental protection of components within the pole against heat, cold, dust, wind, rain, etc.

Waterproofing everything, including all access doors and joints, or other components and systems or circuitry.

Protect against corrosion over time, and the average lifespan of these metals.

In one embodiment, we have a pole structure approximately 30 feet high. In one embodiment, we have a steel pole of 12.5 feet high, with 18″ diameter. In one embodiment, we have a structure with multiple doors and windows for access and signal transmission. In one embodiment, we have power lines, cables, fiber optics, wireless signal, antennas, optical signals, lasers, low voltage line, high voltage line, Internet connectivity, secure lines, secure network, or private network, coming to the pole, or connected or distributed or amplified or monitored or characterized or tested, via pole or through pole.

In one embodiment, we have 3 sections for the pole: top section, middle section, and bottom section. In one embodiment, we have the middle section with shroud and shelves, including antennas for multiple carriers and antenna for our own organization, e.g., for Wi-Fi and/or remote management services. In one embodiment, we have a Metro sign or streetlight or tree shape or statue or figurine or flagpole, to hide or disguise or decorate the pole. In one embodiment, we have different number of access doors and windows on the structure, with different sizes, for repair, inspection, monitoring, installation, upgrades, or testing, which, e.g., gives access to 4 carriers, each for access to its own antenna and devices, separately (or with a common door), with lock or password or biometrics or smart card or badge or RFID or camera, to open or access the door or content.

In one embodiment, we install smart meters or other diagnostic devices, or solar cells plus batteries or sensors or meters or conversion equipment or formatting equipment or security devices or recording devices or optimizing devices or anti-hacking devices or physical security devices or electronic security devices. In one embodiment, we install or upgrade the software or hybrid of hardware/software. In one embodiment, we use metal for/in the pole, or concrete, or fiberglass, or a RF-friendly material, or glass, or wood, or plastic, or alloy, or metal shield, or RF-shield, or signal blocking shield, or signal transmitting material.

In one embodiment, we have heating and/or cooling in the pole. In one embodiment, we have fan for air circulation. In one embodiment, we have insulators for temperature control in the pole. In one embodiment, we have temperature controller device for adjusting temperature in the pole. In one embodiment, we have water-proof material on the gaps and doors to seal and protect the equipment inside the pole.

Appendix 1 shows various styles and shapes for structure of the pole. Appendix 2 shows various styles and shapes for structure of the pole. Appendix 2 also shows a pole structure with 3 sections: top section, middle section (with shelves, shroud, shroud clips, to attach and lock, 2 shroud halves, grooves along the steel frame sliding into the shroud for a more secure fit, and space for holding equipment and antennas for various carriers), and bottom section (with doors, access panels, and windows, with locks and secure means, to limit access to authorized people and only related companies, for various equipment, e.g., power supplies, routers, network switches, network monitoring devices, smart meters, converters, adaptors, packet analyzers, batteries, solar energy devices, surge protectors, and the like). It can accommodate, e.g., 5 wireless service providers. It can shield all equipment. It reduces planning and zoning applications by consolidation, to reduce cost. It increases wireless capacity and coverage for public safety. It enables the Internet of Things (IoT).

Appendix 3 shows a fan installed on top of the bottom section of the pole system/platform/structure, as an example, to circulate the air, for cooling the system or for uniform/equal temperature across the pole length.

Appendix 4 shows, as an example, a smart pole's top-to-bottom bill of materials, with various spec and components for various sections, with their parameters and ratings and locations, within the pole structure, as well as examples of manufacturer and model number, plus height, width, depth, volume, weight, voltage, and power values, plus operating temperature, IP rating, mount, MIMO capabilities, users information, output power, antenna type, bands, technologies used, output (Power Over Ethernet) POE power, Wi-Fi information, mounting location, model description, power and electric head-end equipment, Ethernet ports, and fiber ports information or data.

Appendix 5 (pages 1-2) shows various styles and shapes for structure of the pole. Appendix 5 also shows 3D frontal view (page 3) and 3D view of shroud attachment (page 4), with various shelves and doors or windows, with transparent, translucent, or opaque material, e.g., glass, plastic, metal, wood, fiber, or concrete. Appendix 5 (page 5) also shows various components inside pole, instead of shelves. Appendix 5 (pages 6-8) also shows stealth infrastructure design with Metro sign on it.

Appendix 5 (page 9) shows back view with the shroud attached. The diameter of the pole is 18″, for example, with the shroud attached, and, e.g., 17″, without the shroud or jacket. Each door has an individual built-in lock or security entrance module. The middle section is about 10′, for example, in length. It also shows the bottom of shroud attachment with doors, covers, caps, or access panels. It also shows the foundation with components, e.g., concrete, base, legs, support, armored and reinforced section, and anchor, for stability of the pole. The length of the pole could be between typical 1′-50′ for various applications and locations, with diameter from 1″ to 4′, as circle or rectangle or triangle or square cross sections.

Appendix 5 (page 9) also shows back view without the shroud attached. It shows e.g. 27′ length of the whole pole. It shows removing the shroud exposes a hollow steel frame, which also acts as a cabling track and provides additional structural integrity. Appendix 5 (page 10) shows back views with and without the shroud attached. It shows e.g. 27′ length of the whole pole. It shows removing the shroud exposes a hollow steel pipe, which also acts as a cabling track and provides additional structural integrity, as a variation of the Figure on Page 9.

Appendix 5 (page 11) shows top section without the shroud, with 3″ spacers, e.g., to separate each carrier compartment. It also shows hollow steel cabling frame. In each carrier compartment, the sides of the frame include a 110V receptacle and a fiber/Ethernet jack. It also shows the carrier compartments with an Alcatel Lucent B4 RRH2x60-4R installed, as an example.

Appendix 5 (page 12) shows top section without the shroud. It also shows hollow steel tube runs down the infrastructure. It acts as a cabling track and a structure for mounting the carrier radios. It also shows the carrier radios, as an example.

Appendix 5 (page 13) shows another view of the pole, with an antenna, or a pseudo-omni antenna installed, for the single antenna shared by multiple carriers. Appendix 5 (page 14) shows bottom section of infrastructure for a pole, with, e.g., DAS Worldwide Network & Monitoring, Carrier #1—Core Equipment, Carrier #2—Core Equipment, Carrier #3—Core Equipment, Carrier #4—Core Equipment, Electric Utility Access, and Telecom & Power Street Access, with dimensions shown, as typical values. It also shows base support in the ground, with anchors, and corresponding dimensions, e.g., 3′ depth.

Appendix 5 (page 14) shows some examples: All carrier doors are 1″ apart. The DAS Worldwide door is 3″ above the carrier #1 door. The Telecom & Power Street Access is 3″ above the ground. The Electric Utility Access is 2″ above the Telecom & Power Street Access.

Appendix 6 (pages 1-2) shows the poles with Metro sign, separate and integrated, in the street. Appendix 6 (page 3) shows front 3D view. Appendix 6 (page 4) shows 3D view of shroud attachment. Appendix 6 (page 5) shows 3D view of shroud attachment with radios installed. Appendix 6 (page 6) shows back view with the shroud attached, and back view without the shroud attached. Appendix 6 (page 7) shows outdoor antenna installed for single antenna shared by multiple carriers. Appendix 6 (page 8) shows the fans installed for air circulation. Appendix 6 (page 9) shows the bottom half with all the devices and components as shown, e.g., network and monitoring devices.

Note that the emphasis for Appendix 5 is shelves for the equipment, but Appendix 6 emphasizes the attachments of the equipment on or at the inner pole and shaft or column. Appendix 7 (pages 1-3) teaches the flag pole with different variations, integrated for our system.

Appendix 8 (pages 1-2) shows the street examples for the poles. Appendix 8 (page 3) shows 3D view of the shroud attachment with antenna on top and two doors or jackets or covers. Appendix 8 (page 4) shows 3D view of the shroud attachment with radios installed. Appendix 8 (page 5) shows 3D view of the back view with the shroud attached (on left side), and also, without the shroud attached (on right side). Appendix 8 (page 6) shows the antenna and carrier radios. Appendix 8 (page 7) shows the fans for air circulation. Appendix 8 (page 8) shows the bottom half with core equipment for carriers, as well as utility access and telecom access, with examples of distances.

Here is one embodiment: A system for wireless pole platform for installation in or on a city or rural area, building, road side, transportation station, park, or platform, said system comprising: a top section; a middle section; a bottom section; wherein said middle section comprises shelves to hold equipment from one or more carriers, with antenna; wherein said bottom section comprises one or more doors and windows as access panel for repair, testing, installation, calibration, measurements, or maintenance; wherein said bottom section is attached to ground for stability, with following options or features:

wherein said one or more doors and windows are waterproof

wherein said one or more doors and windows are secured.

wherein said one or more doors and windows are monitored by a center.

wherein said one or more doors and windows are customized for each carrier.

wherein said one or more doors and windows are locked.

wherein said one or more doors and windows are secured by biometrics modules.

said system comprises a heating unit.

said system comprises a cooling unit.

said system comprises a fan unit.

said system comprises insulation for heat transfer.

said system comprises insulation for sound or noise transfer.

said system is stealth for view by a decoration or paint or color or shape.

said system comprises a camera.

said system comprises a password module.

said system comprises a warning module for pole owner or police.

said system comprises an anti-hacking module.

said system comprises a temperature controller.

said system comprises one or more sensors.

said system comprises a calibration or testing device.

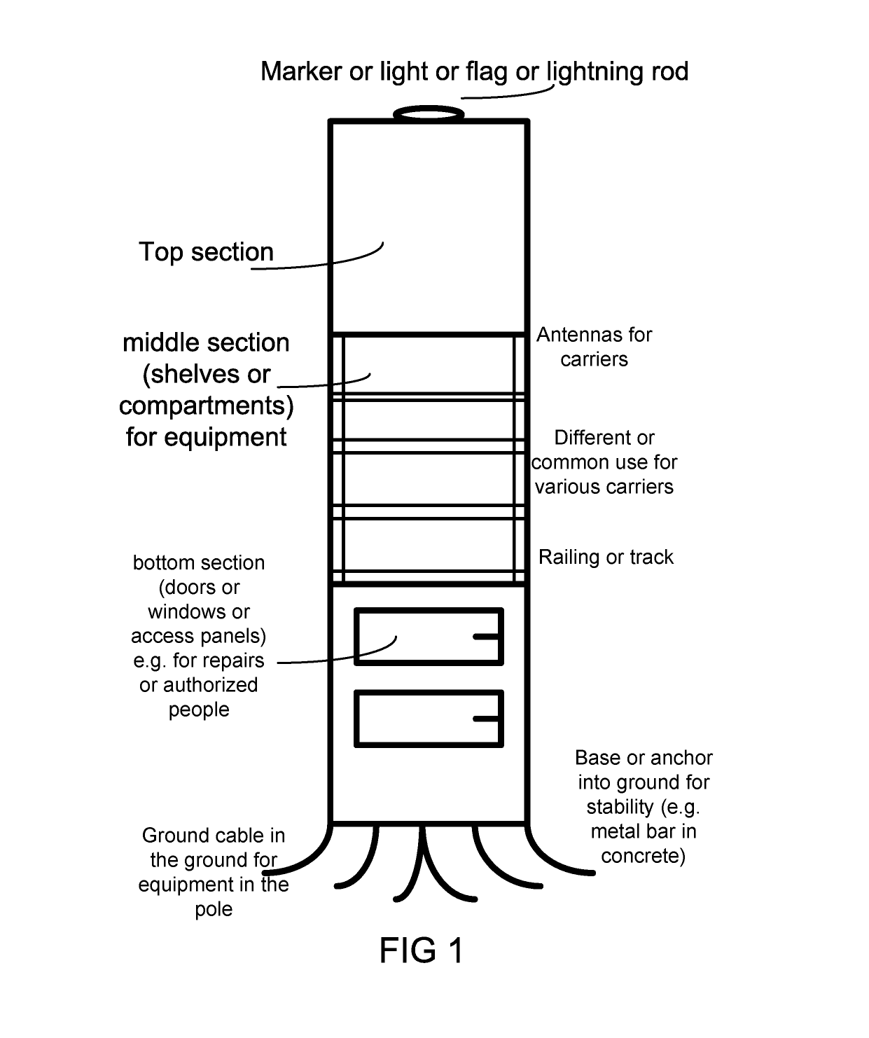

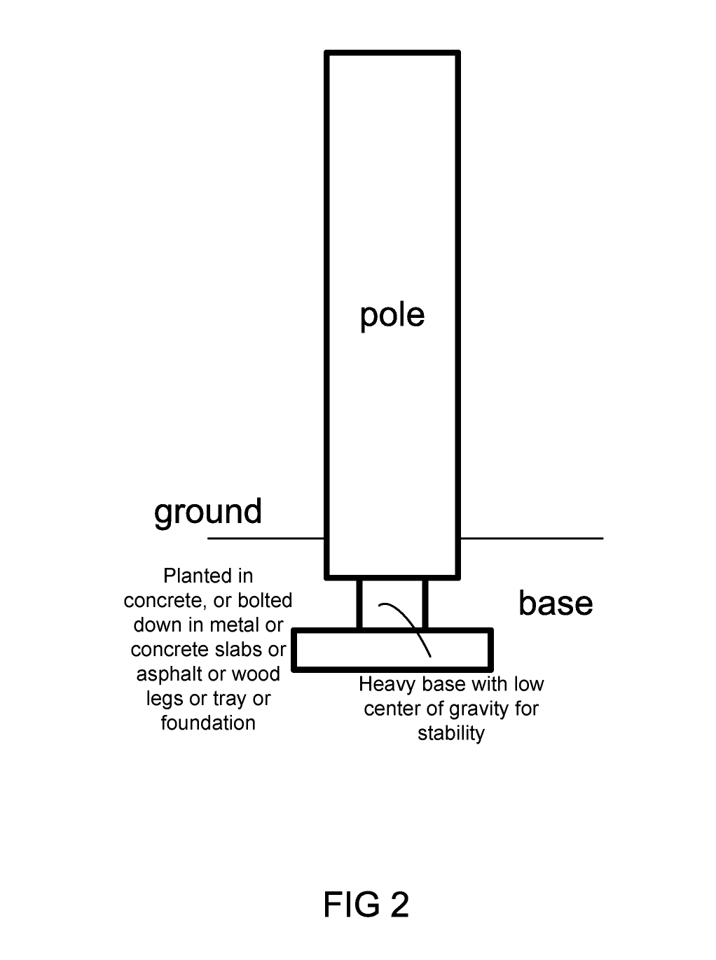

FIG. 1 is for one embodiment, as an example, for our platform system, for pole (or pipe structure or shape) with various sections and components. Also, see Appendices 1-5 for more details. FIG. 2 is for one embodiment, as an example, for our platform system, for pole installed in ground or on it or on a plate or slab or surface or structure or the like.

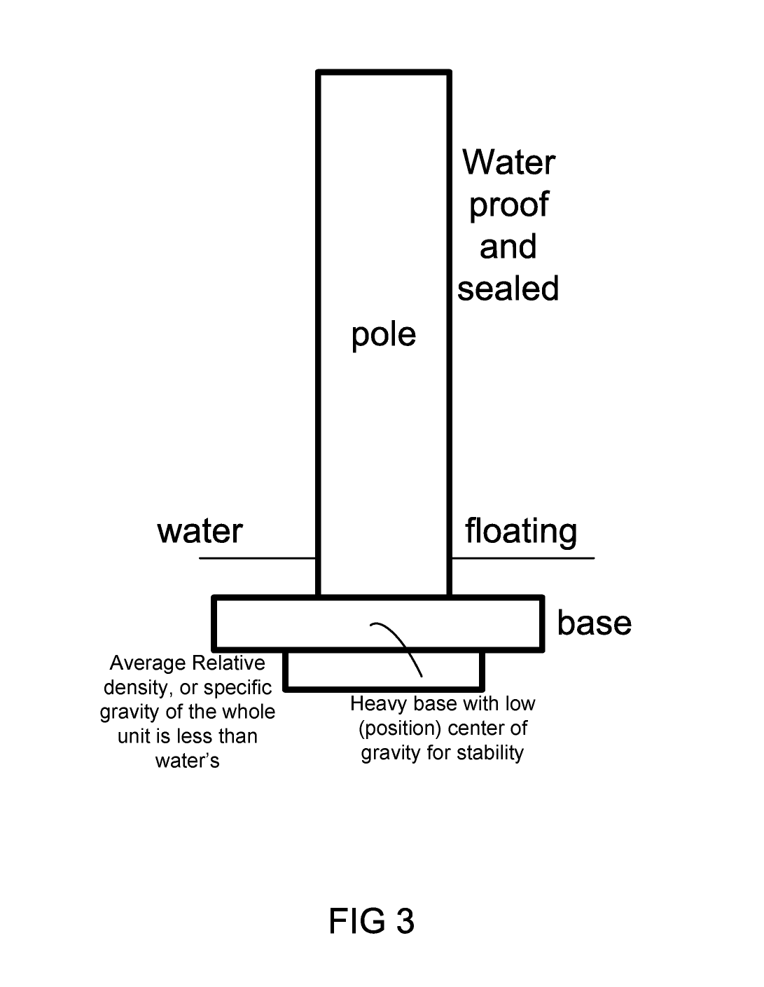

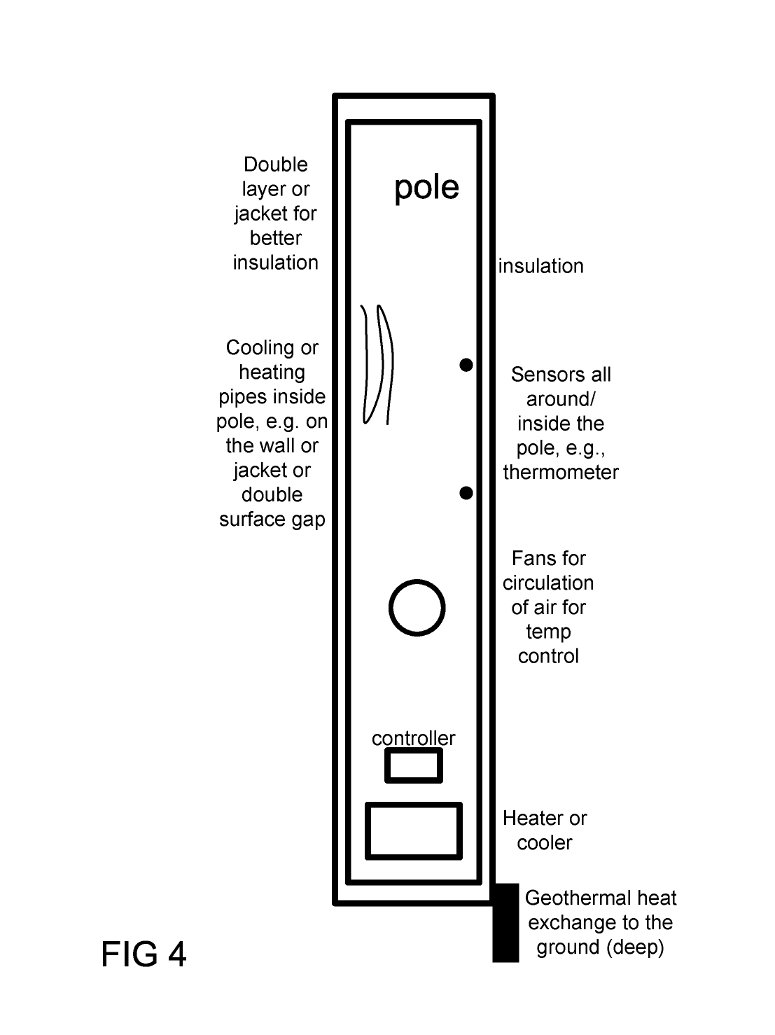

FIG. 3 is for one embodiment, as an example, for our platform system, for pole installed on water, floating on it, on a floater or small boat or wooden or plastic or fiber or metal or synthetic material container, or attached on top of it. FIG. 4 is for one embodiment, as an example, for our platform system, for pole with various heating and cooling systems installed.

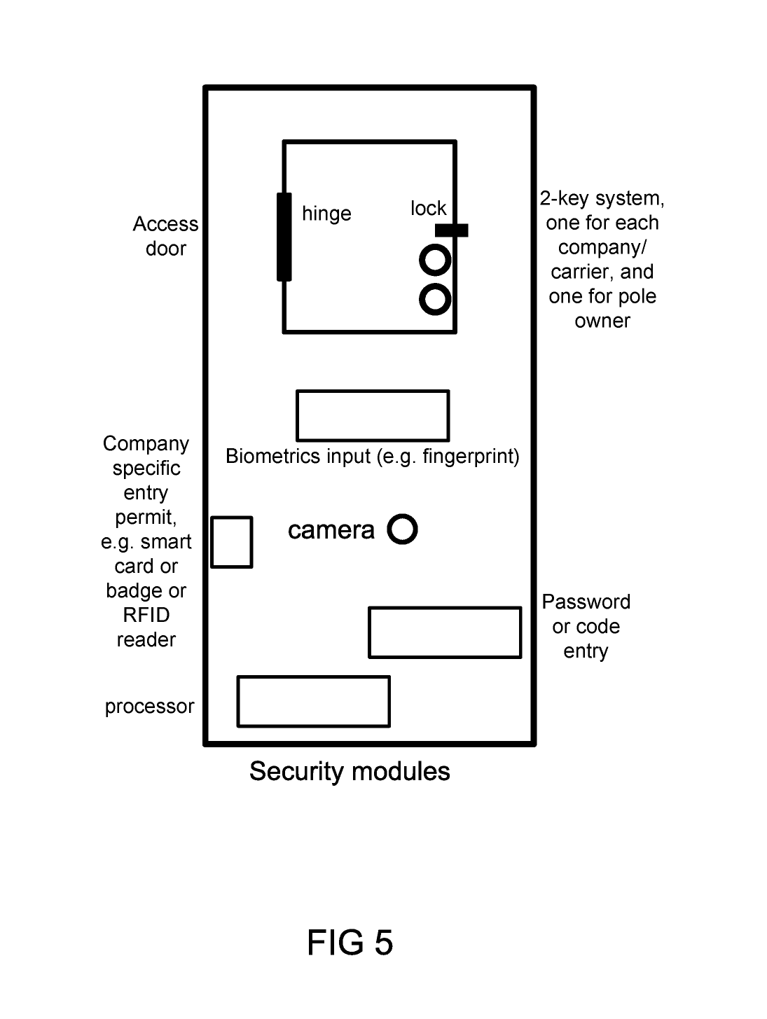

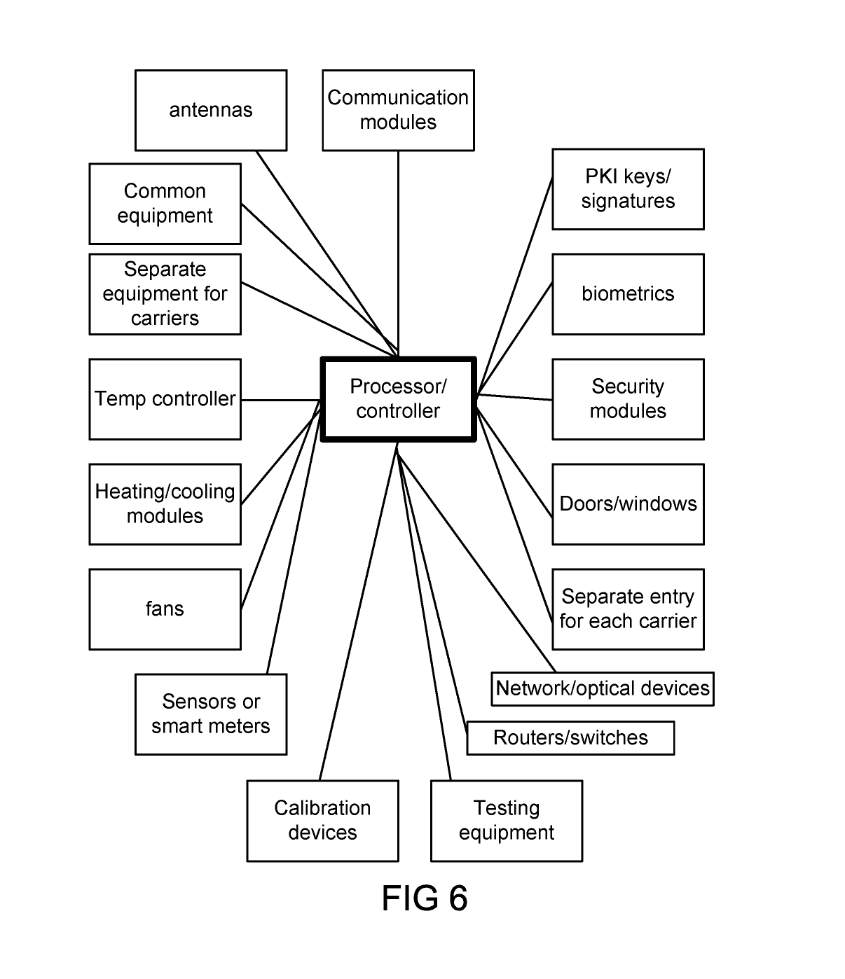

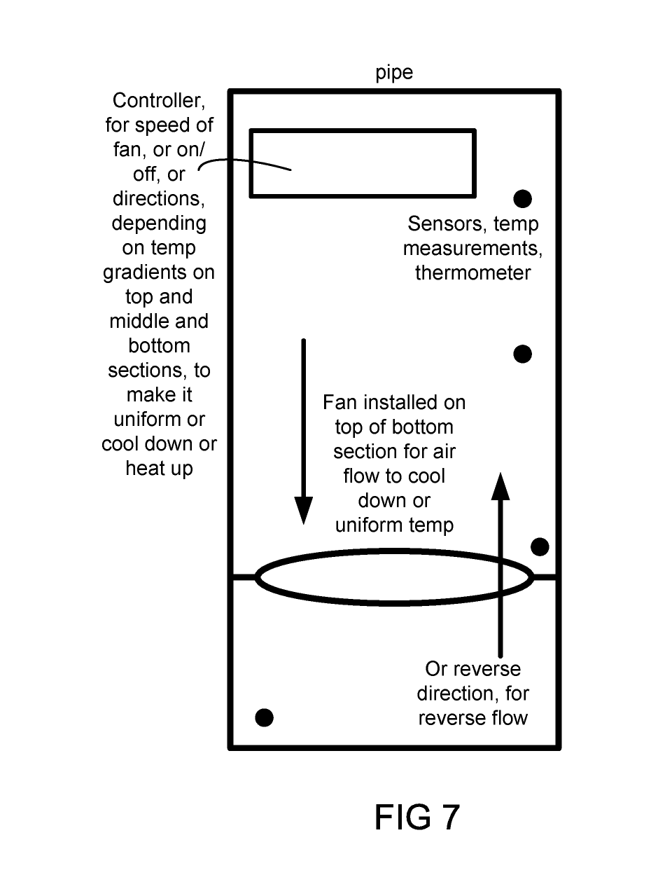

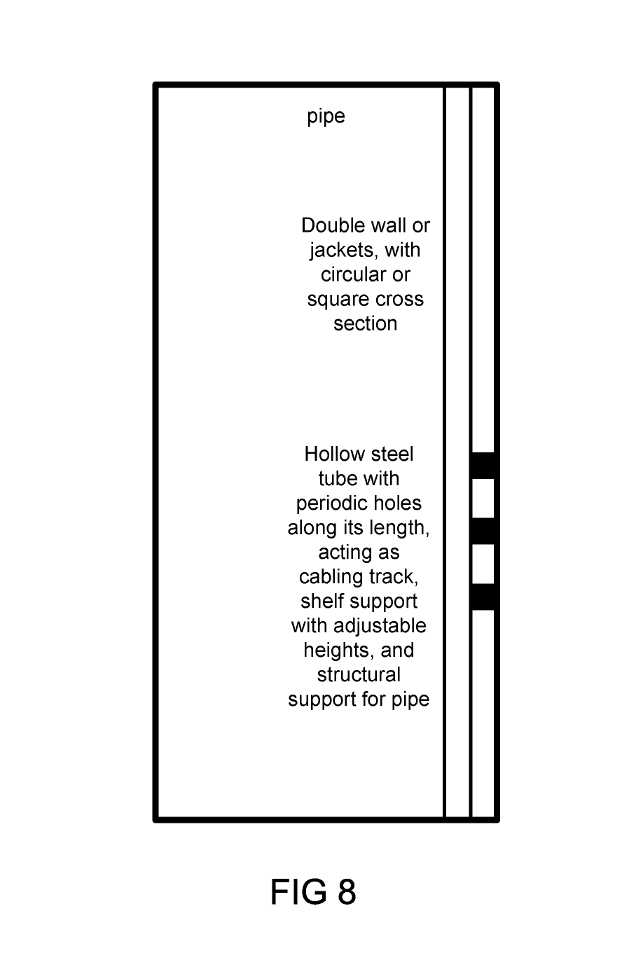

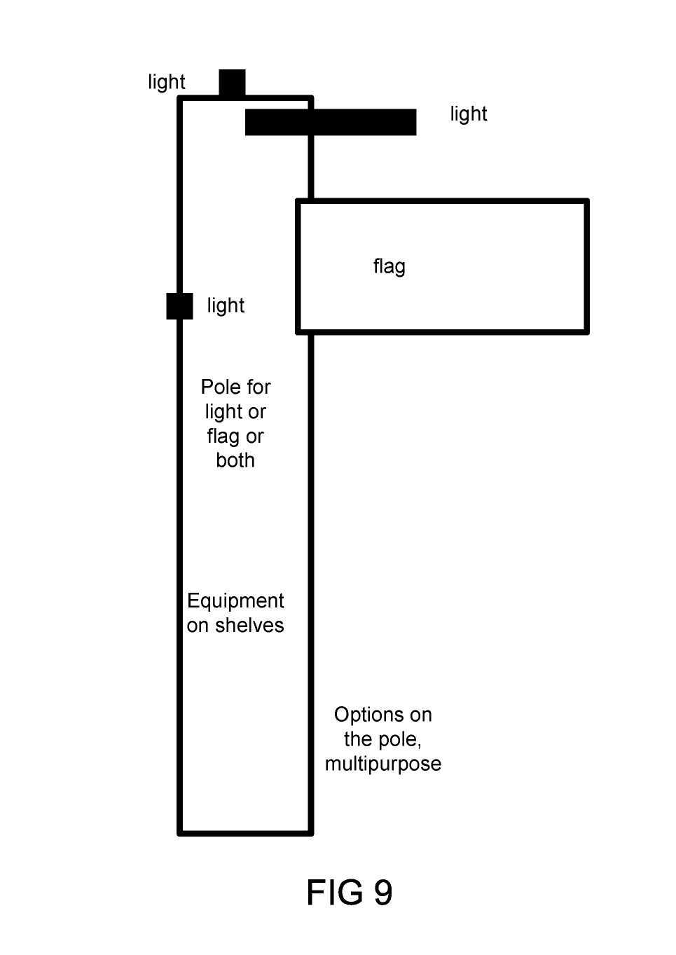

FIG. 5 is for one embodiment, as an example, for our platform system, for pole with various security systems installed. FIG. 6 is for one embodiment, as an example, for our platform system, for pole with various components or subsystems or modules. FIG. 7 is for one embodiment, as an example, for our platform system, for pole with various fan directions and speeds, with one or more fans, installed at different heights. FIG. 8 is for one embodiment, as an example, for our platform system, for pole with double wall and jacket with various features for various functions. FIG. 9 is for one embodiment, as an example, for our platform system, for pole with street lighting option, e.g., at the top section, or attached in the middle or bottom section, and also flag option.

In one embodiment, we have the pole installed on a float or a boat near shore near city, with heavy bottom as anchor and low center of gravity, to keep the pole stable, from toppling down or falling down.

In one embodiment, we have double lock system, where both locks must be opened to open the door. In one embodiment, we have double lock system, where at least one of the locks must be opened to open the door. One lock/key/entry module belongs to specific carrier and the 2^{nd} one belongs to the owner of the pole (us). In one embodiment, we have a master key or master password to open the doors, in case the key or password for the carrier is lost or forgotten, for emergency situation. In one embodiment, we have physical key. In one embodiment, we have electronic key. In one embodiment, we have both types of keys. In one embodiment, we have PKI key/signature, plus biometrics, plus camera, e.g., recognizer for fingerprint, iris, eye, hand, face, signature, thumb, and the like, with database and pattern recognizer modules. In one embodiment, we have a pipe structure for the pole platform.

In one embodiment, in the top section, we have one antenna. In one embodiment, in the top section, we have more than one antennas. In one embodiment, in the top section, we have measurement equipment, or control devices, or calibration modules, or electromagnetic radiation devices or transmitters or receivers. In one embodiment, we have 27-30 ft tower or pole (as an example, for range of pole or tower heights or lengths). In one embodiment, we have lighting pole or flag pole, integrated in our pole. In one embodiment, we have metro sign or pole as self-standing structure, separate or the same as our pole. In one embodiment, we have integration with smart systems, devices, or services, or Internet of Things.

In one embodiment, we use any kind of processor or computer or server or cloud computing or Internet or app or microprocessor or smart phone or tablet to run the process or control it. In one embodiment, we any kind of antenna or any shape of antenna for various lengths for various frequencies or bands. In one embodiment, we use any material for internal or external of the pole, e.g., steel, stainless steel, Al, metal, alloy, concrete, asphalt cover, insulator, wood, treated wood, plastic, fiber, carbon, elastic material, gap fillers, synthetic materials, cloth, fabric, nylon, wool, silicone, PVC, or the like.

We have described in the following figures and appendices all the needed components and spec for the tower and system, to withstand snow, wind, seismic activities, and forces of nature, for stable and strong tower, to continue functioning in most adverse conditions anywhere in the world:

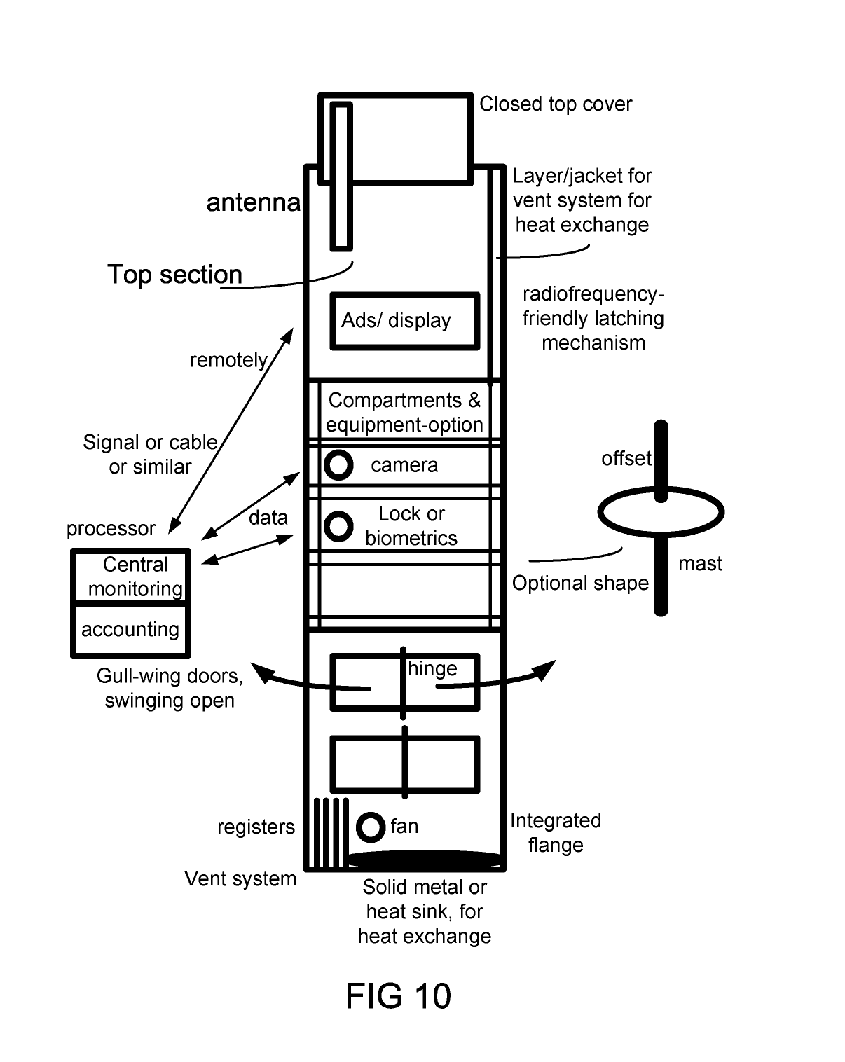

Appendix 9 (20 pages) is the structural calculations for the tower/mast. Appendix 10 (1 page) is the design for seismic and snow. Appendix 11 (1 page) is the design for wind. Appendix 12 (7 pages) is the material, structure, and spec for tower and system. FIG. 10 is a system, for an example, for the tower.

In one embodiment, we have a system for wireless pole platform for installation in or on city, urban or rural area, building, road side, transportation station, park, or platform, said system comprising: one or more sections of remote radio heads; a top antenna; one or more sets of gull wing doors to provide opening for maintenance or inspection; a radiofrequency-friendly latching mechanism to ensure said system remains closed, when said system not being serviced; a closed top cover, to conceal said top antenna; wherein said system is radiofrequency-friendly transparent concealed; wherein said system has integrated flange, to avoid recessed doors; wherein said system has built-in vents to prevent antenna overheat.

In one embodiment, we have a system with the following option(s):

a galvanized steel mast.

galvanized steel rings.

an attachment to a bottom section and structural support.

one or more components for protection against seismic, heavy snowfall, or high winds.

an offset steel mast.

a digital or written signage.

a digital or written signage for advertising.

a digital 3-dimensional signage.

a module or device that captures user data.

system customizes advertising services and signage.

an accounting module for an advertising module.

one or more doors and windows.

one or more waterproof doors and windows.

one or more secured or locked doors and windows.

one or more secured or locked doors and windows, monitored by a center.

one or more biometrics modules.

insulation for sound or noise, or electromagnetic noise or interference.

decoration or paint coverage which is similar to tree or forest in appearance.

a master key or code for opening or for security of windows or doors.

As one embodiment, we have DAS Worldwide Small Cell Concept

Radome Design, for seismic/snow:

Radiofrequency Friendly Transparent Concealment “RFTC” Radome

Reusable Radome design tailored for (3) varying climate conditions:
a. Seismic Activity
b. Heavy Snowfall
c. Moderate East Coast

15′-0″ height to allow for 3 sections of remote radio heads and top antenna

(3) Sets of gull wing doors to provide 37″ opening for maintenance and inspection

RF Friendly latching mechanism to ensure Radome remains closed when not being serviced.

Color customization available through a variety of fiberglass resins

Closed top cover to conceal antenna

Integrated flange design to prevent recessed doors

Galvanized steel mast for RRH attachment

Galvanized steel rings for attachment to bottom section and structural support

Built-in vents to prevent antenna overheat

As one embodiment, we have DAS Worldwide Small Cell Concept Radome Design, for wind:

Radiofrequency Friendly Transparent Concealment “RFTC” Radome

Reusable Radome design tailored for (1) climate condition:
a. High Winds

15′-0″ height to allow for 3 sections of remote radio heads and top antenna

(3) Sets of gull wing doors to provide 37″ opening for maintenance and inspection

RF Friendly latching mechanism to ensure Radome remains closed when not being serviced.

Color customization available through a variety of fiberglass resins

Closed top cover to conceal antenna

Integrated flange design to prevent recessed doors

Galvanized steel mast for RRH attachment

Galvanized steel rings for attachment to bottom section and structural support

Built-in vents to prevent antenna overheat

As discussed, as one embodiment, below are the key features of the pole, for one example:

Radiofrequency Friendly Transparent Concealment “RFTC” Radome design tailored for varying climate conditions (e.g., seismic, heavy snowfall, high winds, and moderate East Coast).

Gull-wing doors to provide 37″ opening and RF-Friendly latching mechanism to ensure Radome remains closed, when not being serviced.

Integrated flange design to prevent recessed doors.

Offset steel mast, used as the “spine” of the of the wireless pole, and additional structural support, provided by the steel ring.

The system for the wireless pole platform comprises digital or written signage, used for advertising, including digital 3-D technology signage and marketing.

The system for the wireless pole platform comprises a module/sub-system that captures user data, to support and customize advertising services and signage. This produces an extra income, from an existing structure/investment.

Any variations of the above teaching are also intended to be covered by this patent application, as well as any combination of the above/teachings.

1. A system for wireless pole platform for installation in or on city, urban or rural area, building, road side, transportation station, park, or platform, said system comprising:
one or more sections of remote radio heads;
a top antenna;
one or more sets of gull wing doors to provide opening for maintenance or inspection;
a radiofrequency-friendly latching mechanism to ensure said system remains closed, when said system not being serviced;
a closed top cover, to conceal said top antenna;
wherein said system is radiofrequency-friendly transparent concealed;
wherein said system has integrated flange, to avoid recessed doors;
wherein said system has built-in vents to prevent antenna overheat.

2. The system for wireless pole platform as recited in claim 1, said system comprises:
a galvanized steel mast.

3. The system for wireless pole platform as recited in claim 1, said system comprises:
galvanized steel rings.

4. The system for wireless pole platform as recited in claim 1, said system comprises:
an attachment to a bottom section and structural support.

5. The system for wireless pole platform as recited in claim 1, said system comprises:
one or more components for protection against seismic, heavy snowfall, or high winds.

6. The system for wireless pole platform as recited in claim 1, said system comprises:
an offset steel mast.

7. The system for wireless pole platform as recited in claim 1, said system comprises:
a digital or written signage.

8. The system for wireless pole platform as recited in claim 1, said system comprises:
a digital or written signage for advertising.

9. The system for wireless pole platform as recited in claim 1, said system comprises:
a digital 3-dimensional signage.

10. The system for wireless pole platform as recited in claim 1, said system comprises:
a module or device that captures user data.

11. The system for wireless pole platform as recited in claim 1, wherein said system customizes advertising services and signage.

12. The system for wireless pole platform as recited in claim 1, said system comprises:
an accounting module for an advertising module.

13. The system for wireless pole platform as recited in claim 1, said system comprises:
one or more doors and windows.

14. The system for wireless pole platform as recited in claim 1, said system comprises:
one or more waterproof doors and windows.

15. The system for wireless pole platform as recited in claim 1, said system comprises:
one or more secured or locked doors and windows.

16. The system for wireless pole platform as recited in claim 1, said system comprises:
one or more secured or locked doors and windows, monitored by a center.

17. The system for wireless pole platform as recited in claim 1, said system comprises:
one or more biometrics modules.

18. The system for wireless pole platform as recited in claim 1, said system comprises:
insulation for sound or noise, or electromagnetic noise or interference.

19. The system for wireless pole platform as recited in claim 1, said system comprises:
decoration or paint coverage which is similar to tree or forest in appearance.

20. The system for wireless pole platform as recited in claim 1, said system comprises:
a master key or code for opening or for security of windows or doors.
